(19) United States
(12) Patent Application Publication
(10) Pub. No.: US 2026/0112362 A1
(43) Pub. Date: Apr. 23, 2026

(54) PRONUNCIATION FEEDBACK GENERATOR

(71) Applicant: QUALCOMM Incorporated, San Diego, CA (US)

(72) Inventors: Yoonhyung LEE, Goyang-si (KR); Jaeseong YOU, Seoul (KR); Jinkyu LEE, Seoul (KR); Seunghan YANG, Incheon (KR)

(21) Appl. No.: 18/921,306

(22) Filed: Oct. 21, 2024

(51) Int. Cl. G10L 15/22; G10L 15/02; G10L 25/51

(52) U.S. Cl. CPC G10L 15/22; G10L 15/02; G10L 25/51; G10L 2015/025; G10L 2015/225

(57) ABSTRACT

A device includes a memory configured to store input audio that corresponds to speech representing a target sentence spoken by a user. The device also includes one or more processors configured to detect a prosody component of the speech. The one or more processors are also configured to detect a phonetic component of the speech. The one or more processors are configured to perform a prosody comparison of a reference prosody component and the detected prosody component. The one or more processors are configured to perform a phonetics comparison of a reference phonetic component and the detected phonetic component. Each of the reference prosody component and the reference phonetic component is based on the target sentence with speech characteristics of the user and having a target pronunciation. The one or more processors are configured to generate an output based on the prosody comparison and the phonetics comparison.

### I. FIELD

The present disclosure is generally related to pronunciation analysis.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate functionality to receive an audio signal from one or more microphones. For example, the audio signal may represent user speech captured by the microphones, external sounds captured by the microphones, or a combination thereof. Such devices may include a language learning application to assist a user in learning a foreign language. For example, a language learning application may play an audio sample, as a phrase or sentence, in a language that the user is learning to provide an example for the user to emulate. The audio sample is typically pre-recorded in another person's voice and has that person's vocal characteristics. The user may find it challenging to separate elements of the audio sample related to correct pronunciation from those that are specific to the other person's unique vocal traits.

### III. SUMMARY

According to one implementation of the present disclosure, a device includes a memory configured to store input audio that corresponds to speech representing a target sentence spoken by a user. The device also includes one or more processors coupled to the memory and configured to detect a prosody component of the speech. The one or more processors are configured to detect a phonetic component of the speech. The one or more processors are configured to perform a prosody comparison of a reference prosody component and the detected prosody component. The reference prosody component is based on the target sentence with speech characteristics of the user and having a target pronunciation. The one or more processors are configured to perform a phonetics comparison of a reference phonetic component and the detected phonetic component. The reference phonetic component is based on the target sentence with the speech characteristics of the user and having the target pronunciation. The one or more processors are configured to generate an output based on the prosody comparison and the phonetics comparison.

According to another implementation of the present disclosure, a method includes obtaining, at a device, input audio that corresponds to speech representing a target sentence spoken by a user. The method also includes detecting, at the device, a prosody component of the speech. The method also includes detecting, at the device, a phonetic component of the speech. The method also includes performing, at the device, a prosody comparison of a reference prosody component and the detected prosody component. The reference prosody component is based on the target sentence with speech characteristics of the user and having a target pronunciation. The method also includes performing, at the device, a phonetics comparison of a reference phonetic component and the detected phonetic component. The reference phonetic component is based on the target sentence with the speech characteristics of the user and having the target pronunciation. The method also includes generating, at the device, an output based on the prosody comparison and the phonetics comparison.

According to another implementation of the present disclosure, a non-transitory computer-readable medium includes instructions that, when executed by one or more processors, cause the one or more processors to obtain input audio that corresponds to speech representing a target sentence spoken by a user. The instructions further cause the one or more processors to detect a prosody component of the speech. The instructions further cause the one or more processors to detect a phonetic component of the speech. The instructions further cause the one or more processors to perform a prosody comparison of a reference prosody component and the detected prosody component. The reference prosody component is based on the target sentence with speech characteristics of the user and having a target pronunciation. The instructions further cause the one or more processors to perform a phonetics comparison of a reference phonetic component and the detected phonetic component. The reference phonetic component is based on the target sentence with the speech characteristics of the user and having the target pronunciation. The instructions further cause the one or more processors to generate an output based on the prosody comparison and the phonetics comparison.

According to another implementation of the present disclosure, an apparatus includes means for obtaining input audio that corresponds to speech representing a target sentence spoken by a user. The apparatus also includes means for detecting a prosody component of the speech. The apparatus further includes means for detecting a phonetic component of the speech. The apparatus also includes means for performing a prosody comparison of a reference prosody component and the detected prosody component. The reference prosody component is based on the target sentence with speech characteristics of the user and having a target pronunciation. The apparatus also includes means for performing a phonetics comparison of a reference phonetic component and the detected phonetic component. The reference phonetic component is based on the target sentence with the speech characteristics of the user and having the target pronunciation. The apparatus further includes means for generating an output based on the prosody comparison and the phonetics comparison.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative aspect of a system operable to generate pronunciation feedback, in accordance with some examples of the present disclosure.

FIG. 2 is a diagram of an illustrative aspect of a system operable to train a factorized speech encoder of the system of FIG. 1, in accordance with some examples of the present disclosure.

FIG. 3 is a diagram of an illustrative aspect of components and operations associated with a factorized speech encoder of the system of FIG. 1, in accordance with some examples of the present disclosure.

FIG. 4A is a diagram of an illustrative aspect of components and operations associated with a pronunciation analyzer of the system of FIG. 1, in accordance with some examples of the present disclosure.

FIG. 4B is a diagram of examples of elements of a graphical user interface generated by the pronunciation analyzer of the system of FIG. 1, in accordance with some examples of the present disclosure.

FIG. 5 is a diagram of an illustrative aspect of operations associated with generating a user speech embedding of the system of FIG. 1, in accordance with some examples of the present disclosure.

FIG. 6 illustrates an example of an integrated circuit operable to generate pronunciation feedback, in accordance with some examples of the present disclosure.

FIG. 7 is a diagram of a mobile device operable to generate pronunciation feedback, in accordance with some examples of the present disclosure.

FIG. 8 is a diagram of a headset operable to generate pronunciation feedback, in accordance with some examples of the present disclosure.

FIG. 9 is a diagram of a wearable electronic device operable to generate pronunciation feedback, in accordance with some examples of the present disclosure.

FIG. 10 is a diagram of a mixed reality or augmented reality glasses device operable to generate pronunciation feedback, in accordance with some examples of the present disclosure.

FIG. 11 is a diagram of earbuds operable to generate pronunciation feedback, in accordance with some examples of the present disclosure.

FIG. 12 is a diagram of a voice-controlled speaker system operable to generate pronunciation feedback, in accordance with some examples of the present disclosure.

FIG. 13 is a diagram of a headset, such as a virtual reality, mixed reality, or augmented reality headset, operable to generate pronunciation feedback, in accordance with some examples of the present disclosure.

FIG. 14 is a diagram of a first example of a vehicle operable to generate pronunciation feedback, in accordance with some examples of the present disclosure.

FIG. 15 is a diagram of a second example of a vehicle operable to generate pronunciation feedback, in accordance with some examples of the present disclosure.

FIG. 16 is a diagram of a particular implementation of a method of generating pronunciation feedback that may be performed by the device of FIG. 1, in accordance with some examples of the present disclosure.

FIG. 17 is a block diagram of a particular illustrative example of a device that is operable to generate pronunciation feedback, in accordance with some examples of the present disclosure.

### V. DETAILED DESCRIPTION

Typically, a user using a language learning application speaks a target sentence in a language that the user is learning. The language learning application receives input audio via a microphone that corresponds to speech representing the target sentence spoken by the user. The language learning application may generate pronunciation feedback based on reference audio that corresponds to speech representing the target sentence spoken by another person. For example, the reference audio is typically pre-recorded in the other person's voice and has that person's vocal characteristics. The language learning application outputs the reference audio and the input audio as feedback. The user can find it challenging to determine differences between the reference audio and the input audio that are related to incorrect pronunciation from those that are specific to the other person's unique vocal traits.

Systems and methods of generating pronunciation feedback are disclosed. In an example, a speech analyzer obtains reference audio that corresponds to synthesized speech that represents the target sentence having speech characteristics of the user. To illustrate, the reference audio emulates speech of the user speaking the target sentence in a target pronunciation (e.g., a target language, dialect, etc.). The speech analyzer generates pronunciation feedback based on a comparison of the input audio and the reference audio. For example, the speech analyzer outputs the reference audio and the input audio as feedback. Because the reference audio emulates speech of the user, the user is more likely to easily determine that differences between the reference audio and the input audio correspond to incorrect pronunciation. The feedback is more informative for the user and can support faster learning.

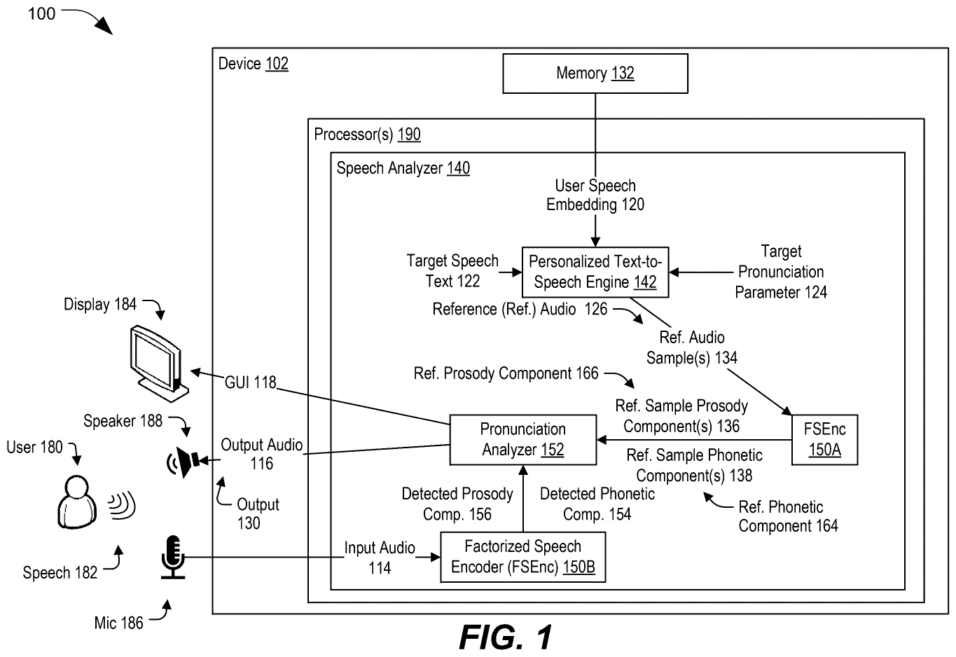

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 190 of FIG. 1), which indicates that in some implementations the device 102 includes a single processor 190 and in other implementations the device 102 includes multiple processors 190. For ease of reference herein, such features are generally introduced as “one or more” features and are subsequently referred to in the singular or optional plural (as indicated by “(s)”) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 1, multiple factorized speech encoders are illustrated and associated with reference numbers 150A and 150B. When referring to a particular one of these factorized speech encoders, such as a factorized speech encoder (FSEnc) 150A, the distinguishing letter “A” is used.

However, when referring to any arbitrary one of these factorized speech encoders or to these factorized speech encoders as a group, the reference number 150 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality”refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model”or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows—a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data.” The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

Referring to FIG. 1, a particular illustrative aspect of a system configured to generate pronunciation feedback is disclosed and generally designated 100. The system 100 includes a device 102 that is configured to be coupled to a display device 184, a microphone 186, a speaker 188, or a combination thereof. It should be understood that although the display device 184, the microphone 186, and the speaker 188 are depicted as external to the device 102 as an illustrative example, in some other examples at least one of the display device 184, the microphone 186, or the speaker 188 can be integrated in the device 102.

The device 102 includes one or more processors 190 coupled to a memory 132. The one or more processors 190 include a speech analyzer 140 that includes a personalized text-to-speech (TTS) engine 142, a pronunciation analyzer 152, or both. The pronunciation analyzer 152 is coupled to a factorized speech encoder (FSEnc) 150A and a FSEnc 150B. In an example, the personalized TTS engine 142 is coupled via the FSEnc 150A to the pronunciation analyzer 152. In some embodiments, the FSEnc 150A and the FSEnc 150B are combined in a single FSEnc 150.

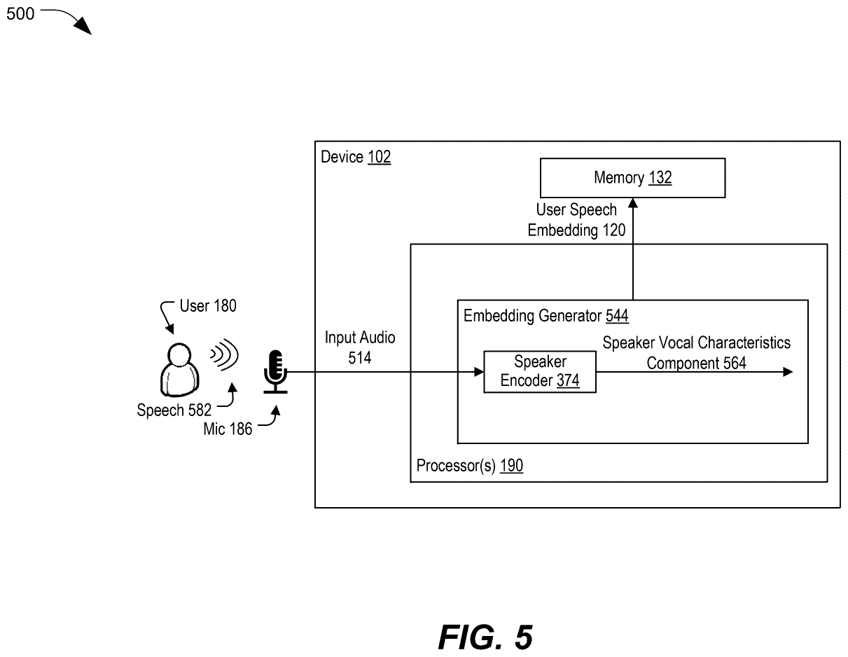

The memory 132 is configured to store a user speech embedding 120 that is representative of speech (e.g., enrollment speech) of a user 180. In a particular aspect, the user speech embedding 120 corresponds to a numerical representation of speech characteristics of the user 180, as further described with reference to FIG. 5. As an example, the speech characteristics include at least one of timbre, pitch, rhythm, intensity (e.g., loudness), articulation, speech rate, or pronunciation of the user 180.

The personalized TTS engine 142 is configured to use the user speech embedding 120 to process target speech text 122, optionally based on a target pronunciation parameter 124, to generate reference audio 126 that includes one or more reference audio samples 134. The reference audio 126 represents synthetic speech having the speech characteristics of the user 180 that are represented by the user speech embedding 120 and having a target pronunciation (e.g., indicated by the target pronunciation parameter 124). In some embodiments, the personalized TTS engine 142 includes an end-to-end speech synthesis model that is based on variational inference with adversarial learning for end-to-end speech synthesis (VITS). In these embodiments, the personalized TTS engine 142 provides the user speech embedding 120, the target speech text 122, and optionally the target pronunciation parameter 124, to the end-to-end speech synthesis model to generate the reference audio 126. In a particular aspect, the target pronunciation parameter 124 is based on a configuration setting, default data, a user input, or a combination thereof.

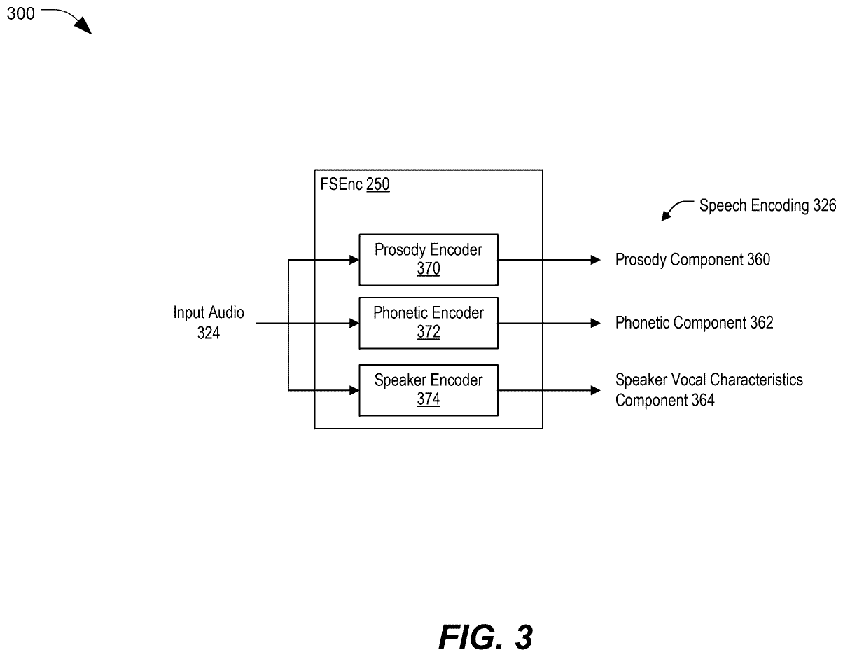

An FSEnc 150 is configured to process audio to generate an encoder output corresponding to multiple feature spaces associated with different factors. For example, the FSEnc 150A is configured to process the reference audio 126 to generate a reference encoder output that includes at least a reference phonetic component 164 and a reference prosody component 166, as further described with reference to FIG. 3. Similarly, the FSEnc 150B is configured to process input audio 114 from the microphone 186 to generate an encoder output that includes at least a detected phonetic component 154 and a detected prosody component 156.

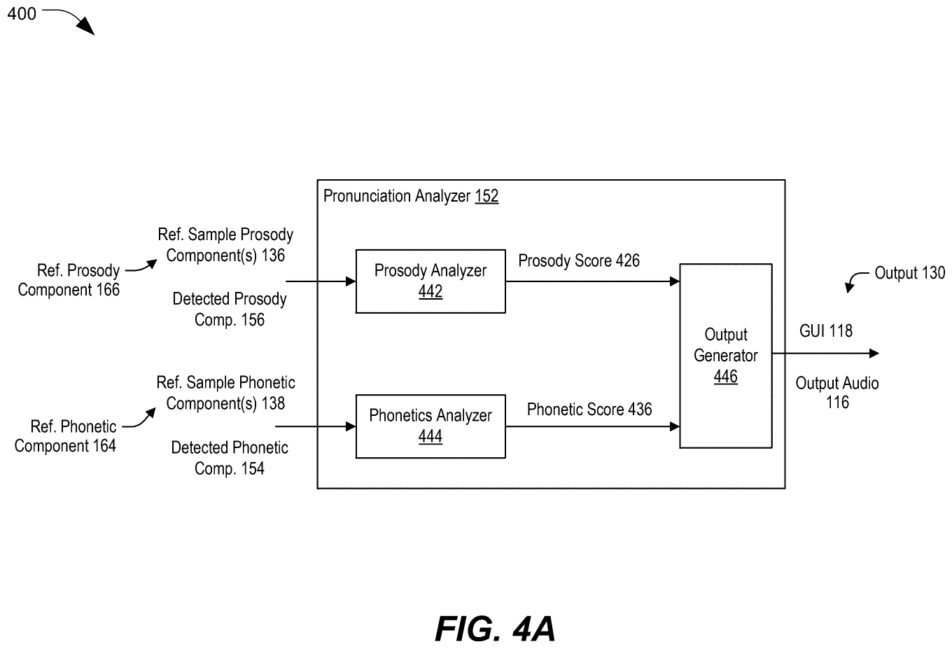

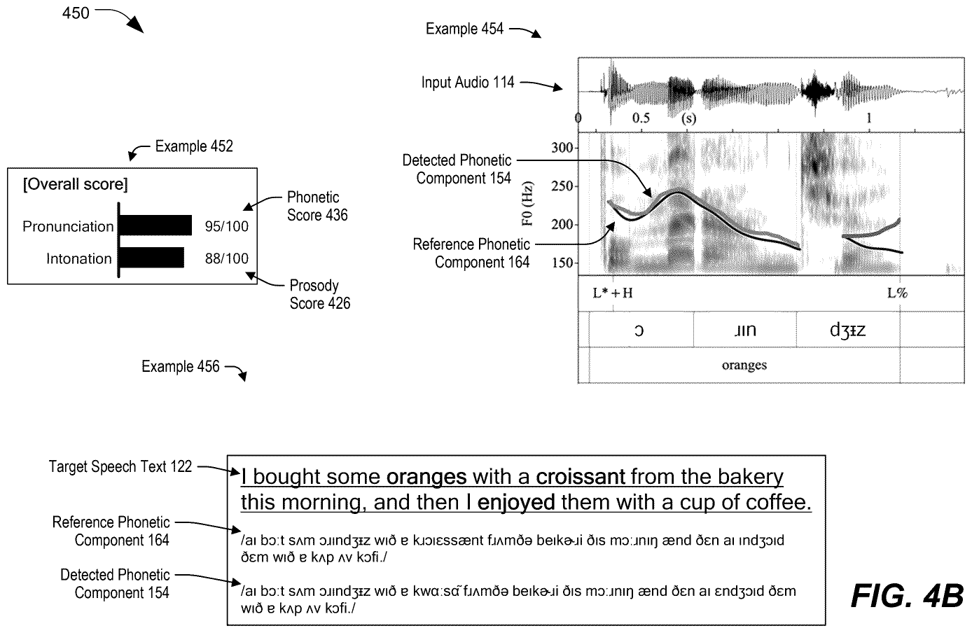

The pronunciation analyzer 152 is configured to perform a phonetics comparison of the detected phonetic component 154 and the reference phonetic component 164. The pronunciation analyzer 152 is also configured to perform a prosody comparison of the detected prosody component 156 and the reference prosody component 166. The pronunciation analyzer 152 is configured to generate an output 130 based on the phonetics comparison, the prosody comparison, or both, as further described with reference to FIGS. 4A-4B.

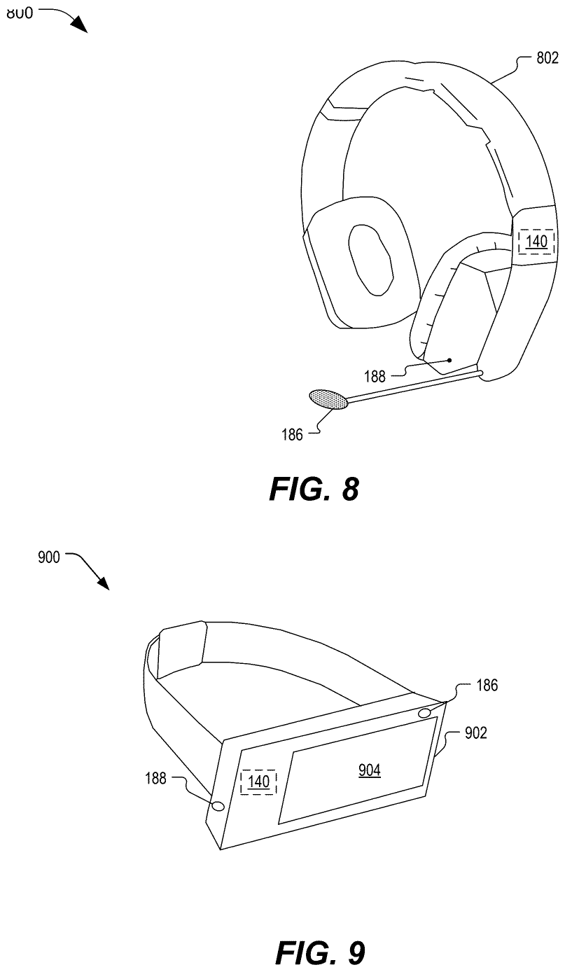

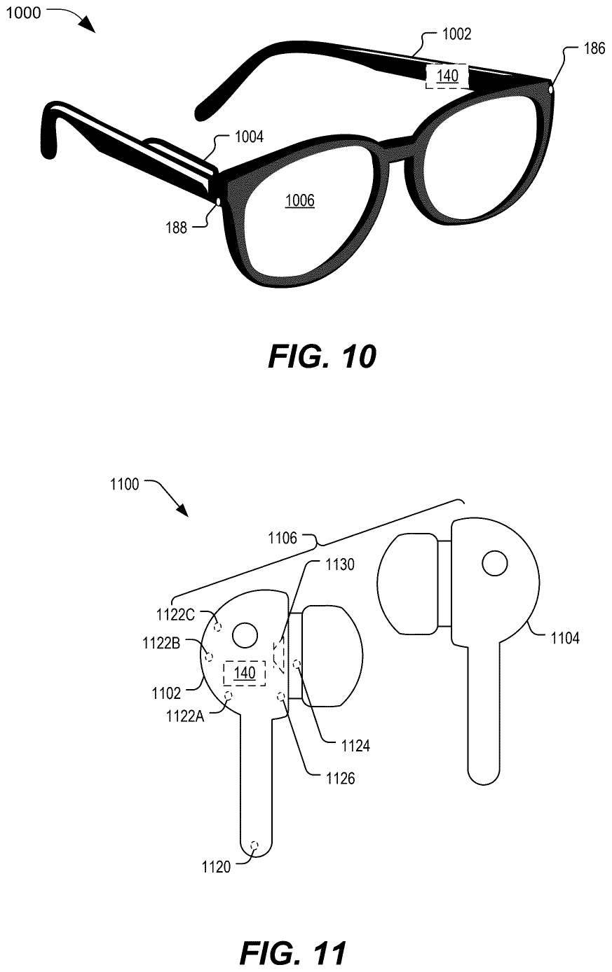

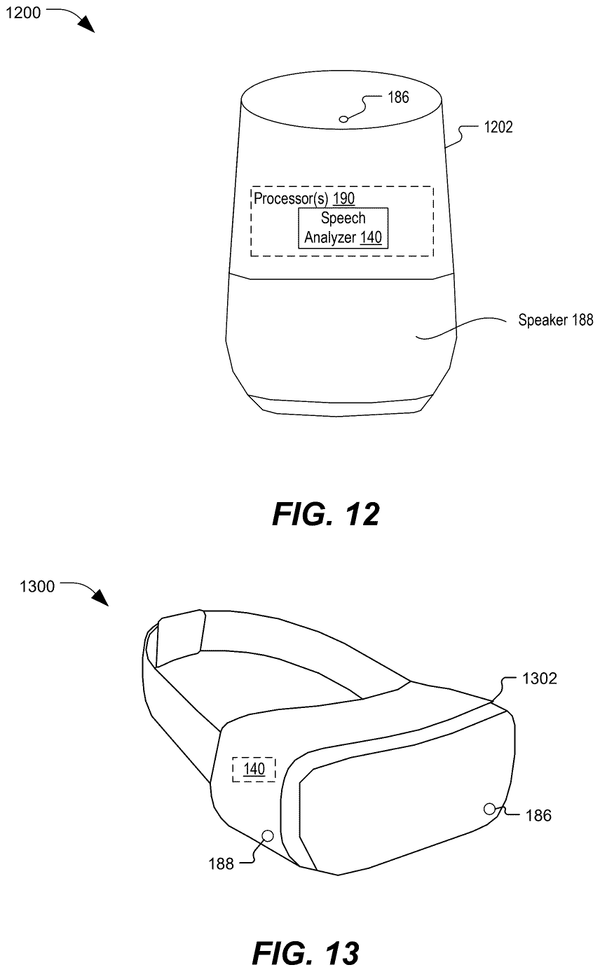

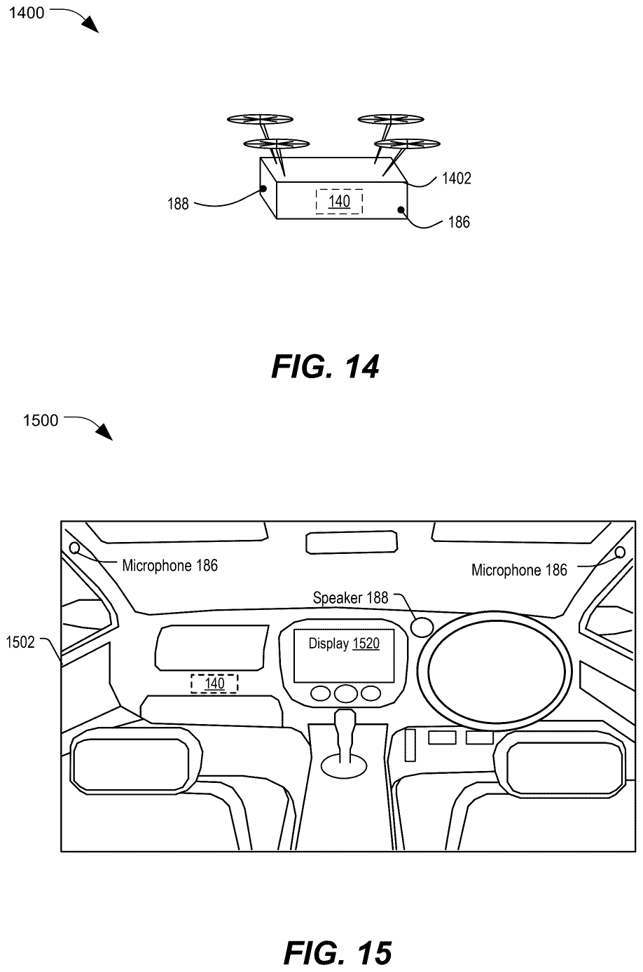

In some embodiments, the device 102 corresponds to or is included in one of various types of devices. In an illustrative example, the one or more processors 190 are integrated in a headset device that includes the microphone 186, such as described further with reference to FIG. 8. In other examples, the one or more processors 190 are integrated in at least one of a mobile phone or a tablet computer device, as described with reference to FIG. 7, a wearable electronic device, as described with reference to FIG. 9, a mixed reality or augmented reality glasses device, as described with reference to FIG. 10, earbuds, as described with reference to FIG. 11, a voice-controlled speaker system, as described with reference to FIG. 12, or a virtual reality, mixed reality, or augmented reality headset, as described with reference to FIG. 13. In another illustrative example, the one or more processors 190 are integrated into a vehicle that also includes the microphone 186, such as described further with reference to FIG. 14 and FIG. 15.

During operation, the speech analyzer 140 generates reference audio 126 that corresponds to synthesized speech that represents target speech text 122 (e.g., “It's a lovely day today”) to be used in a pronunciation feedback session of a user 180 for a target pronunciation (e.g., Texan English). In some examples, the reference audio 126 is generated during the pronunciation feedback session. In some other examples, the target speech text 122 is predetermined and the speech analyzer 140 generates the reference audio 126 prior to the pronunciation feedback session.

The speech analyzer 140 uses the personalized TTS engine 142 to process the target speech text 122 based on the user speech embedding 120, and optionally a target pronunciation parameter 124, to generate the reference audio 126. The target speech text 122 represents a target sentence (e.g., “It's a lovely day today”). As used herein, a target “sentence”can represent one or more words, one or more phrases, a list of items, etc.

The target pronunciation can correspond to a language, a dialect, a region, etc. The target pronunciation parameter 124 represents the target pronunciation (e.g., “Texan English”).

Optionally, in some embodiments, the personalized TTS engine 142 is configured to generate reference audio corresponding to a single target pronunciation (e.g., the target pronunciation) and the target pronunciation parameter 124 is not provided as input to the personalized TTS engine 142. In some other embodiments, the target pronunciation parameter 124 is provided as input to the personalized TTS engine 142.

The reference audio 126 corresponds to synthesized speech that represents target speech text 122 (e.g., “It's a lovely day today”) having the speech characteristics of the user 180 and having the target pronunciation (e.g., Texan English). The reference audio 126 includes one or more reference audio samples 134. A reference audio sample 134 emulates the target sentence (e.g., “It's a lovely day today”) spoken by the user 180 and having the target pronunciation (e.g., Texan English). To illustrate, the reference audio sample 134 represents synthetic speech having the speech characteristics of the user 180 that are represented by the user speech embedding 120 and having the target pronunciation (e.g., indicated by the target pronunciation parameter 124).

In examples in which the personalized TTS engine 142 generates multiple reference audio samples 134, each of the multiple reference audio samples 134 corresponds to synthesized speech that emulates the target sentence spoken by the user 180 (e.g., represents the target sentence having the speech characteristics of the user 180) in a respective distinct speech manner and having the target pronunciation. For example, the reference audio samples 134 correspond to various ways (e.g., happily, sadly, angrily, urgently, etc.) the user 180 might speak the target sentence (e.g., “It's a lovely day today”) in the target pronunciation (e.g., Texan English).

The FSEnc 150A processes the reference audio 126 to generate an encoder output that includes at least a reference phonetic component 164 and a reference prosody component 166, as further described with reference to FIG. 3. In a particular aspect, a prosody component (e.g., the reference phonetic component 164) corresponds to rhythmic speech qualities. In an example, the reference prosody component 166 includes a numerical representation of a pattern of speech, such as pitch, accentuation, rhythm, loudness, juncture, speech rate, or a combination thereof, of the synthetic speech represented by the reference audio 126. In a particular aspect, a phonetic component (e.g., the reference phonetic component 164) corresponds to speech sounds (e.g., phonemes). In an example, the reference phonetic component 164 includes a numerical representation of articulation, manner of articulation (e.g., stop, nasal, fricative), place of articulation (e.g., at the lips for “p” vs. at the alveolar ridge for “t”), voicing (e.g., voiced sounds like “b” vs. voiceless sounds like “p”), consonants and vowels, duration, or a combination thereof, of the synthetic speech represented by the reference audio 126.

In examples in which the reference audio 126 includes one or more reference audio samples 134, the FSEnc 150A processes each of the reference audio sample(s) 134 to generate a corresponding reference sample prosody component 136 and a corresponding reference sample phonetic component 138. The reference prosody component 166 includes one or more reference sample prosody components 136 and the reference phonetic component 164 includes one or more reference sample phonetic components 138. In a particular aspect, the FSEnc 150A stores the reference phonetic component 164, the reference prosody component 166, or both, in the memory 132.

During the pronunciation feedback session, the microphone 186 generates input audio 114 representing speech 182 of the user 180 captured by the microphone 186. For example, the speech 182 corresponds to the target sentence (corresponding to the target speech text 122) spoken by the user 180. In a particular aspect, the memory 132 is configured to store the input audio 114.

The speech analyzer 140 detects a phonetic component of the speech 182 and detects a prosody component of the speech 182. For example, the FSEnc 150B processes the input audio 114 to generate an encoder output that includes at least a detected phonetic component 154 and a detected prosody component 156 of the speech 182, as further described with reference to FIG. 3. In an example, the detected prosody component 156 includes a numerical representation of a pattern of speech, such as pitch, accentuation, rhythm, loudness, juncture, speech rate, or a combination thereof, of the speech 182 represented by the input audio 114. In an example, the detected phonetic component 154 includes a numerical representation of articulation, manner of articulation, place of articulation, voicing, consonants and vowels, duration, or a combination thereof, of the speech 182 represented by the input audio 114.

The pronunciation analyzer 152 performs a prosody comparison of the detected prosody component 156 and the reference prosody component 166, performs a phonetics comparison of the detected phonetic component 154 and the reference phonetic component 164, and generates an output 130 (e.g., pronunciation feedback) based on the prosody comparison and the phonetics comparison, as further described with reference to FIGS. 4A-4B. In an example, the prosody comparison is based on a comparison of the detected prosody component 156 and each of the one or more reference sample prosody components 136, and the phonetics comparison is based on the detected phonetic component 154 and each of the one or more reference sample phonetic components 138.

Optionally, in some embodiments, the output 130 includes a graphical user interface (GUI) 118 that indicates results of at least the prosody comparison or the phonetics comparison, as further described with reference to FIGS. 4A-4B. In some examples, the GUI 118 indicates the results of at least the prosody comparison or the phonetics comparison aligned with respective speech sounds (e.g., phonemes) of the target speech text 122.

Optionally, in some embodiments, the output 130 includes output audio 116 that is based on the input audio 114, the reference audio 126, or both. The speech analyzer 140 provides the output audio 116 to the speaker 188. In an example, the pronunciation analyzer 152 selects a particular reference audio sample 134 that has a corresponding reference sample prosody component 136 that is closest among the one or more reference sample prosody components 136 to the detected prosody component 156, has a corresponding reference sample phonetic component 138 that is closest among the one or more reference sample phonetic components 138 to the detected phonetic component 154, or both. The pronunciation analyzer 152 provides the selected reference audio sample 134 and the input audio 114 as the output audio 116 to the speaker 188.

Optionally, in some embodiments, the pronunciation analyzer 152 provides the output 130 to a large language model (LLM) to generate feedback on a presentation that includes at least the target sentence (e.g., the target speech text 122). In an example, the pronunciation analyzer 152 provides the input audio 114 and the reference audio sample(s) 134 to the LLM to generate the feedback. In some examples, the feedback includes at least one of speech speed feedback (e.g., “you're speaking too fast”), pronunciation suggestion (e.g., “prosody is ok, phonetics can be improved to match a reference audio sample”), or speech duration feedback (e.g., “presentation is predicted to take 17 minutes for the user 180 in the target pronunciation”).

A technical advantage of the system 100 thus includes providing pronunciation feedback that is more targeted to the user 180 and provides more useful information. For example, the pronunciation analyzer 152 generates the output 130 based on a comparison of the input audio 114 to reference audio 126 that has the speech characteristics of the user 180 (instead of another user). The output 130 makes it easier for the user 180 to distinguish elements that correspond to incorrect pronunciation.

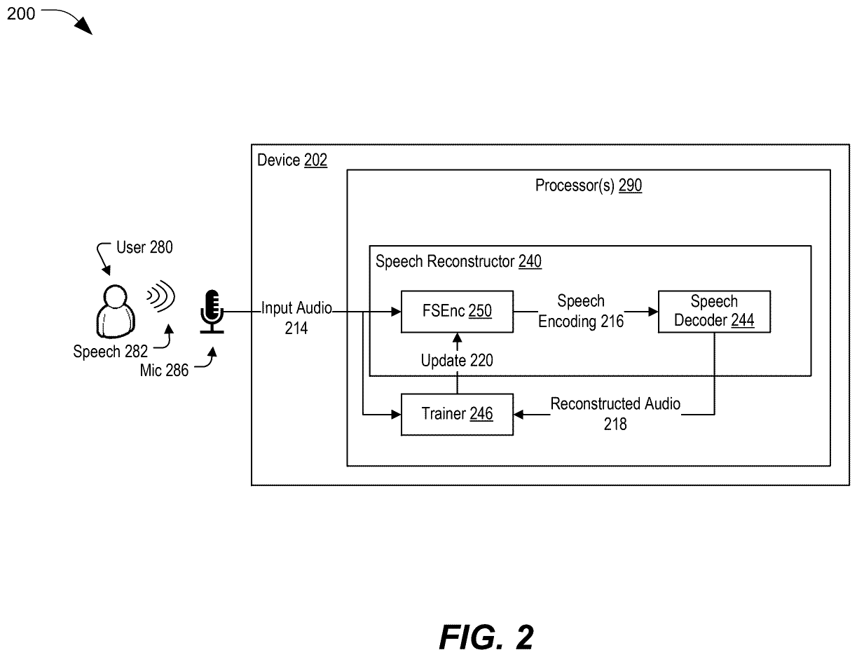

Referring to FIG. 2, a particular illustrative aspect of a system configured to train a FSEnc 250 is disclosed and generally designated 200, in accordance with some examples of the present disclosure. In a particular aspect, the system 100 of FIG. 1 includes one or more components of the system 200.

The system 200 includes a device 202 coupled to a microphone 286. The device 202 includes one or more processors 290 that include a speech reconstructor 240 coupled to a trainer 246. The speech reconstructor 240 includes an FSEnc 250 coupled to a speech decoder 244. The speech reconstructor 240 obtains input audio 214 from the microphone 286. The input audio 214 represents speech 282 of a user 280. In some aspects, the user 280 is different from the user 180 of FIG. 1. For example, the FSEnc 250 can be trained on speech of one or more users, independently of whether the one or more users include the user 180.

The FSEnc 250 processes the input audio 214 to generate an encoder output that includes a speech encoding 216, as further described with reference to FIG. 3. The speech decoder 244 processes (e.g., decodes) the speech encoding 216 to generate reconstructed audio 218. The trainer 246 selectively updates the FSEnc 250 based on a comparison of the reconstructed audio 218 and the input audio 214. For example, the trainer 246 determines a loss metric based on a comparison of the reconstructed audio 218 and the input audio 214, and sends an update 220 to the FSEnc 250 based on the loss metric to update one or more model parameters of an end-to-end speech synthesis model included in the FSEnc 250. To illustrate, the trainer 246 iteratively updates the FSEnc 250 to reduce the loss metric to a particular threshold, up to a count of iterations, or both.

In a particular aspect, the FSEnc 250 corresponds to the FSEnc 150A, the FSEnc 150B of FIG. 1, or both. Optionally, in some embodiments, the device 202 is external to the device 102 of FIG. 1 and provides the FSEnc 250 (e.g., model parameters) to the device 102. In some other embodiments, the device 102 of FIG. 1 includes the device 202. In these embodiments, the microphone 286 includes the microphone 186, the one or more processors 190 include the one or more processors 290, or both. In a particular aspect, the one or more processors 190 of FIG. 1 include the speech reconstructor 240, the trainer 246, or both.

Referring to FIG. 3, a diagram 300 is shown of an illustrative aspect of operations associated with an FSEnc 250, in accordance with some examples of the present disclosure. In some aspects, the FSEnc 250 corresponds to the FSEnc 150A, the FSEnc 150B of FIG. 1, or both.

The FSEnc 250 includes a prosody encoder 370, a phonetic encoder 372, and a speaker encoder 374. The FSEnc 250 is configured to process input audio 324 to generate an encoder output that includes a speech encoding 326. For example, the prosody encoder 370 is configured to process the input audio 324 to generate a prosody component 360, the phonetic encoder 372 is configured to process the input audio 324 to generate a phonetic component 362, and the speaker encoder 374 is configured to process the input audio 324 to generate a speaker vocal characteristics component 364. The speech encoding 326 includes the prosody component 360, the phonetic component 362, and the speaker vocal characteristics component 364.

In an example, the input audio 324 includes one or more audio samples. The prosody encoder 370 is configured to process an audio sample to generate a sample prosody component. The prosody component 360 includes one or more sample prosody components corresponding to the one or more audio samples. The phonetic encoder 372 is configured to process the audio sample to generate a sample phonetic component. The phonetic component 362 includes one or more sample phonetic components corresponding to the one or more audio samples. The speaker encoder 374 is configured to process the audio sample to generate a sample speaker vocal characteristics component. The speaker vocal characteristics component 364 includes one or more sample speaker vocal characteristics components corresponding to the one or more audio samples.

During training, the input audio 324 corresponds to the input audio 214 of FIG. 2 and the speech encoding 326 corresponds to the speech encoding 216. During a pronunciation feedback session, a FSEnc 150 includes at least the prosody encoder 370 and the phonetic encoder 372. In some embodiments, the speaker encoder 374 is absent or disabled in the FSEnc 150 during the pronunciation feedback session.

During a pronunciation feedback session, in a particular example, the FSEnc 250 corresponds to the FSEnc 150A of FIG. 1, the input audio 324 corresponds to the reference audio 126, the prosody component 360 corresponds to the reference prosody component 166, and the phonetic component 362 corresponds to the reference phonetic component 164. In another example, the FSEnc 250 corresponds to the FSEnc 150B of FIG. 1, the input audio 324 corresponds to the input audio 114, the prosody component 360 corresponds to the detected prosody component 156, and the phonetic component 362 corresponds to the detected phonetic component 154. Optionally, in some embodiments, the speech analyzer 140 uses a speaker encoder 374 to process input audio (e.g., the input audio 114 or enrollment audio) to generate the user speech embedding 120, as further described with reference to FIG. 5.

Referring to FIG. 4A, a diagram 400 is shown of an illustrative aspect of operations associated with the pronunciation analyzer 152, in accordance with some examples of the present disclosure. The pronunciation analyzer 152 includes a prosody analyzer 442 and a phonetics analyzer 444 that are each coupled to an output generator 446.

The prosody analyzer 442 is configured to generate a prosody score 426 based on a comparison of the detected prosody component 156 and the reference prosody component 166. In some examples, the reference prosody component 166 includes one or more reference sample prosody components 136, and the prosody analyzer 442 generates the prosody score 426 based on a comparison of the detected prosody component 156 and each of the one or more reference sample prosody components 136. In an example, the detected prosody component 156 corresponds to a first point in a prosody feature space, a reference sample prosody component 136 corresponds to a second point in the prosody feature space, and a prosody score is based on a distance between the first point and the second point.

In some aspects, the prosody analyzer 442, in response to determining that the reference prosody component 166 includes multiple reference sample prosody components 136, determines multiple prosody scores based on a comparison of the detected prosody component 156 and each of the multiple reference sample prosody components 136 and determines the prosody score 426 based on the multiple prosody scores. Optionally, in some embodiments, the prosody analyzer 442 selects the lowest (or highest) of the multiple prosody scores as the prosody score 426. In other embodiments, the prosody analyzer 442 selects an average (e.g., a mean, median, or mode) of the multiple prosody scores as the prosody score 426.

The phonetics analyzer 444 is configured to generate a phonetic score 436 based on a comparison of the detected phonetic component 154 and the reference phonetic component 164. In some examples, the reference phonetic component 164 includes one or more reference sample phonetic components 138, and the phonetics analyzer 444 generates the phonetic score 436 based on a comparison of the detected phonetic component 154 and each of the one or more reference sample phonetic components 138. In an example, the detected phonetic component 154 corresponds to a first point in a phonetic feature space, a reference sample phonetic component 138 corresponds to a second point in the phonetic feature space, and a phonetic score is based on a distance between the first point and the second point.

In some aspects, the phonetics analyzer 444, in response to determining that the reference phonetic component 164 includes multiple reference sample phonetic components 138, determines multiple phonetic scores based on a comparison of the detected phonetic component 154 and each of the multiple reference sample phonetic components 138 and determines the phonetic score 436 based on the multiple phonetic scores. Optionally, in some embodiments, the phonetics analyzer 444 selects the lowest (or highest) of the multiple phonetic scores as the phonetic score 436. In other embodiments, the phonetics analyzer 444 selects an average (e.g., a mean, median, or mode) of the multiple phonetic scores as the phonetic score 436.

Referring to FIG. 4B, a diagram 450 is shown of examples of one or more elements of the GUI 118 of FIG. 1, in accordance with some examples of the present disclosure. An example 452 of an element of the GUI 118 includes a representation of the phonetic score 436 and the prosody score 426. To illustrate, the GUI 118 includes a bar graph with a first bar representing the phonetic score 436 and a second bar representing the prosody score 426.

In some examples, the first bar includes a first visual indication (e.g., a color, an icon, label, etc.) that the phonetic score 436 is greater than a pronunciation threshold. In some examples, the second bar includes a second visual indication (e.g., a color, an icon, label, etc.) that the prosody score 426 is greater than a first intonation threshold and is less than a second intonation threshold.

An example 454 of an element of the GUI 118 includes a representation of the detected phonetic component 154 and a representation of the reference phonetic component 164 aligned with speech sounds (e.g., phonemes) of the input audio 114. In other examples, the GUI 118 can include a representation of the detected phonetic component 154 and a representation of the reference phonetic component 164 (e.g., the one or more reference sample phonetic components 138) aligned with speech sounds (e.g., phonemes) of the input audio 114, the reference audio 126, the target speech text 122, or a combination thereof. In a particular aspect, a distance (e.g., an area) between the representation of the detected phonetic component 154 and the representation of the reference phonetic component 164 indicates the phonetic score 436.

Similarly, the GUI 118 can include a representation of the detected prosody component 156 and a representation of the reference prosody component 166 (e.g., the one or more reference sample prosody components 136) aligned with speech sounds (e.g., phonemes) of the input audio 114, the reference audio 126, the target speech text 122, or a combination thereof. In a particular aspect, a distance (e.g., an area) between the representation of the detected prosody component 156 and the representation of the reference prosody component 166 indicates the prosody score 426.

An example 456 of an element of the GUI 118 includes a representation of the target speech text 122, a representation of the reference phonetic component 164 (e.g., at least a representative one of the one or more reference sample phonetic components 138), and a representation of the detected phonetic component 154. The representation of the reference phonetic component 164 and the representation of the detected phonetic component 154 are aligned with the representation of speech sounds (e.g., words) of the target speech text 122. In some examples, the GUI 118 includes a visual indication (e.g., color, icon, text, etc.) when a speech sound (e.g., a phoneme) of the target speech text 122 is associated with a phonetic score 436 that satisfies a phonetic threshold.

Referring to FIG. 5, a diagram 500 is shown of an illustrative aspect of operations associated with generating a user speech embedding 120 of the system 100 of FIG. 1, in accordance with some examples of the present disclosure. The one or more processors 190 include an embedding generator 544 that is configured to generate the user speech embedding 120 that represents speech characteristics of the user 180.

Optionally, in some embodiments, the embedding generator 544 includes a speaker encoder 374 of an FSEnc 250. In a particular aspect, the trainer 246 trains the speaker encoder 374 during training of the FSEnc 250, as described with reference to FIG. 2. The speaker encoder 374 is configured to obtain input audio 514 representing speech 582 of the user 180 and to process the input audio 514 to generate a speaker vocal characteristics component 564. The embedding generator 544 is configured to generate the user speech embedding 120 based on the speaker vocal characteristics component 564.

The speaker vocal characteristics component 564 represents speech characteristics of the user 180 detected in the input audio 514. In some aspects, the speech characteristics include at least one of timbre, pitch, rhythm, intensity (e.g., loudness), articulation, speech rate, or pronunciation of the user 180. One or more speech characteristics are influenced by biological factors of the user 180, such as anatomy of the vocal tract, neurological factors, genetic influences, hormonal factors, health and physiology, developmental factors, etc. People can have speech idiosyncrasies, such as preferred speech rates, common pauses, and filler words (e.g., “um,” “uh”), that can be represented by the speaker vocal characteristics component 564. In a particular aspect, the speaker vocal characteristics component 564 relies on relatively stable, speaker-specific acoustic and physiological properties. These properties, like vocal tract characteristics and voice quality, can remain generally consistent for a user independently of prosody or phonetic components of speech.

Optionally, in some embodiments, the embedding generator 544 obtains first input audio 514 representing the speech 582 of the user 180 at a first time, and obtains second input audio 514 representing the speech 582 of the user 180 at a second time that is subsequent to the first time. In some embodiments, the first input audio 514 corresponds to the user 180 speaking a first enrollment sentence, and the second input audio 514 corresponds to the user 180 speaking a second enrollment sentence. In some aspects, an enrollment sentence corresponds to a sentence, a phrase, a keyword, etc. In some aspects, the enrollment sentence is pre-determined. For example, the user 180 reads a script corresponding to one or more enrollment sentences. In other aspects, the enrollment sentence is not pre-determined. For example, the embedding generator 544 obtains the input audio 514 during use of the device 102 (e.g., a phone) by the user 180.

The embedding generator 544 uses the speaker encoder 374 to process the first input audio 514 to generate first speaker vocal characteristics component 564 corresponding to the first time. Similarly, the embedding generator 544 uses the speaker encoder 374 to process the second input audio 514 to generate second speaker vocal characteristics component 564 corresponding to the second time. The embedding generator 544 generates the user speech embedding 120 based on the first speaker vocal characteristics component 564 and the second speaker vocal characteristics component 564. In some examples, the user speech embedding 120 includes numerical feature values that are based on an average (e.g., mean, median, or mode) of first numerical feature values of the first speaker vocal characteristics component 564 and second numerical feature values of the second speaker vocal characteristics component 564

In a particular aspect, the embedding generator 544 obtains the first input audio 514 and the second input audio 514 during a single session (e.g., an enrollment session or a user session). In another aspect, the embedding generator 544 obtains the first input audio 514 during a first session and obtains the second input audio during a second session that is subsequent to the first session. In this aspect, the embedding generator 544 can assign a higher weight to the second speaker vocal characteristics component 564 (e.g., corresponding to the more recent session) than a weight assigned to the first speaker vocal characteristics component 564, and determine the user speech embedding 120 based on a weighted combination of the first speaker vocal characteristics component 564 and the second speaker vocal characteristics component 564. The user speech embedding 120 can thus get dynamically updated as speech characteristics of the user 180 change over time.

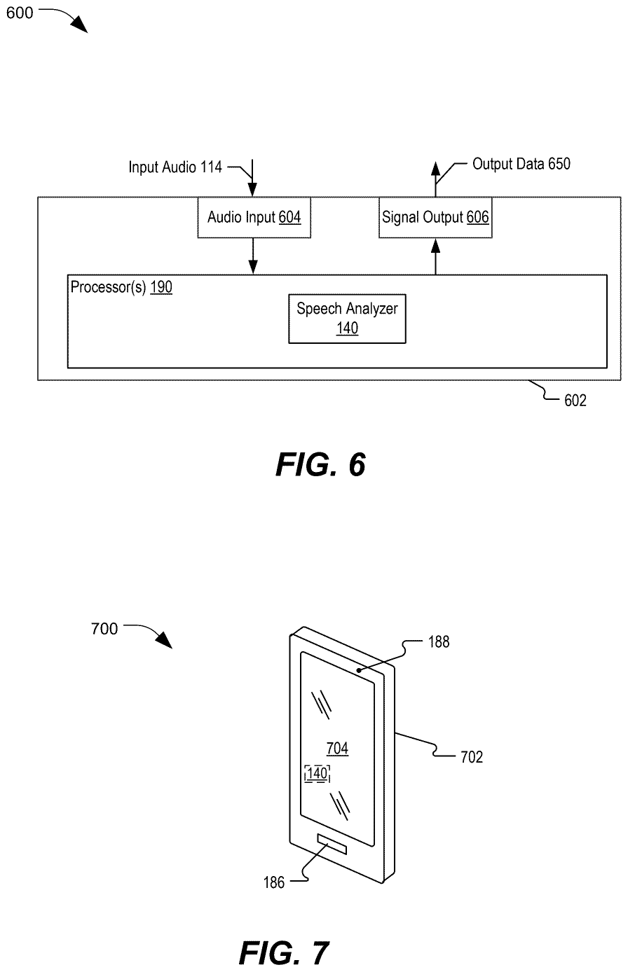

FIG. 6 depicts an embodiment 600 of the device 102 as an integrated circuit 602 that includes the one or more processors 190. The integrated circuit 602 also includes an audio input 604, such as one or more bus interfaces, to enable the input audio 114 to be received for processing. The integrated circuit 602 also includes a signal output 606, such as a bus interface, to enable sending of output data 650, such as the output 130, the output audio 116, the GUI 118 of FIG. 1, the prosody score 426, the phonetic score 436 of FIG. 4A, or a combination thereof. The integrated circuit 602 enables implementation of pronunciation feedback generation as a component in a system that includes microphones, such as a mobile phone or tablet as depicted in FIG. 7, a headset as depicted in FIG. 8, a wearable electronic device as depicted in FIG. 9, a mixed reality or augmented reality glasses device, as described with reference to FIG. 10, earbuds, as described with reference to FIG. 11, a voice-controlled speaker system as depicted in FIG. 12, a virtual reality, mixed reality, or augmented reality headset as depicted in FIG. 13, or a vehicle as depicted in FIG. 14 or FIG. 15.

FIG. 7 depicts an embodiment 700 in which the device 102 includes a mobile device 702, such as a phone or tablet, as illustrative, non-limiting examples. The mobile device 702 includes the microphone 186, the speaker 188, and a display screen 704.

Components of the one or more processors 190, including one or more components of the speech analyzer 140, are integrated in the mobile device 702. The speech analyzer 140 is illustrated using dashed lines to indicate internal components that are not generally visible to a user of the mobile device 702. In a particular example, the speech analyzer 140 operates to detect user voice activity, which is then processed to perform one or more operations at the mobile device 702, such as to launch a graphical user interface or otherwise display other information associated with the user's speech at the display screen 704 (e.g., via an integrated “smart assistant” application). For example, the speech analyzer 140 detects the speech 182, processes the speech 182, and provides the GUI 118 to the display screen 704.

FIG. 8 depicts an embodiment 800 in which the device 102 includes a headset device 802. The headset device 802 includes the microphone 186 and the speaker 188. Components of the one or more processors 190, including one or more components of the speech analyzer 140, are integrated in the headset device 802. In a particular example, the speech analyzer 140 operates to detect user voice activity (e.g., the speech 182), which may cause the headset device 802 to perform one or more operations at the headset device 802, to transmit output data (e.g., the output audio 116, the GUI 118, the output 130, or a combination thereof) corresponding to the user voice activity to a second device (not shown) for further processing, or both.

FIG. 9 depicts an embodiment 900 in which the device 102 includes a wearable electronic device 902, illustrated as a “smart watch.” The microphone 186, the speaker 188, and one or more components of the speech analyzer 140 are integrated into the wearable electronic device 902. In a particular example, the speech analyzer 140 operates to detect user voice activity, which is then processed to perform one or more operations at the wearable electronic device 902, such as to launch a graphical user interface or otherwise display other information associated with the user's speech at a display screen 904 of the wearable electronic device 902. To illustrate, the wearable electronic device 902 may include a display screen that is configured to display a notification based on user speech detected by the wearable electronic device 902. In a particular example, the wearable electronic device 902 includes a haptic device that provides a haptic notification (e.g., vibrates) in response to detection of user voice activity. For example, the haptic notification can cause a user to look at the wearable electronic device 902 to see a displayed notification indicating detection of the speech 182, the GUI 118 of FIG. 1, the prosody score 426, the phonetic score 436 of FIG. 4A, or a combination thereof. The wearable electronic device 902 can thus alert a user with a hearing impairment or a user wearing a headset that pronunciation feedback is available.

FIG. 10 depicts an embodiment 1000 in which the device 102 includes a portable electronic device that corresponds to augmented reality or mixed reality glasses 1002. The glasses 1002 include a holographic projection unit 1004 configured to project visual data onto a surface of a lens 1006 or to reflect the visual data off of a surface of the lens 1006 and onto the wearer's retina. The microphone 186, the speaker 188, one or more components of the speech analyzer 140, or a combination thereof, are integrated into the glasses 1002. The speech analyzer 140 may function to generate the output 130 of FIG. 1 based on the input audio 114 received from the microphone 186. In a particular example, the holographic projection unit 1004 is configured to display a notification indicating that user speech detected in the input audio 114. In a particular example, the holographic projection unit 1004 is configured to display a notification indicating the GUI 118, the prosody score 426, the phonetic score 436, or a combination thereof. For example, the notification can be superimposed on the user's field of view at a particular position that coincides with a location of a source of output audio 116. To illustrate, the sound may be perceived by the user as emanating from the direction of the notification.

FIG. 11 depicts an embodiment 1100 in which the device 102 includes a portable electronic device that corresponds to a pair of earbuds 1106 that includes a first earbud 1102 and a second earbud 1104. Although earbuds are described, it should be understood that the present technology can be applied to other in-ear or over-ear playback devices.

The first earbud 1102 includes a first microphone 1120, such as a high signal-to-noise microphone positioned to capture the voice of a wearer of the first earbud 1102, an array of one or more other microphones configured to detect ambient sounds and spatially distributed to support beamforming, illustrated as microphones 1122A, 1122B, and 1122C, an “inner” microphone 1124 proximate to the wearer's ear canal (e.g., to assist with active noise cancelling), and a self-speech microphone 1126, such as a bone conduction microphone configured to convert sound vibrations of the wearer's ear bone or skull into an audio signal.

In a particular embodiment, the first microphone 1120 corresponds to the microphone 186 and the microphones 1122A, 1122B, and 1122C correspond to multiple instances of the microphone 186, and audio signals generated by the microphones 1120 and 1122A, 1122B, and 1122C are provided to the speech analyzer 140. The speech analyzer 140 may function to generate the output 130 based on the audio signals. In some embodiments, the speech analyzer 140 may further be configured to process audio signals from one or more other microphones of the first earbud 1102, such as the inner microphone 1124, the self-speech microphone 1126, or both.

The second earbud 1104 can be configured in a substantially similar manner as the first earbud 1102. In some embodiments, the speech analyzer 140 of the first earbud 1102 is also configured to receive one or more audio signals generated by one or more microphones of the second earbud 1104, such as via wireless transmission between the earbuds 1102, 1104, or via wired transmission in embodiments in which the earbuds 1102, 1104 are coupled via a transmission line. In other embodiments, the second earbud 1104 also includes a speech analyzer 140, enabling techniques described herein to be performed by a user wearing a single one of either of the earbuds 1102, 1104.

In some embodiments, the earbuds 1102, 1104 are configured to automatically switch between various operating modes, such as a passthrough mode in which ambient sound is played via a speaker 1130, a playback mode in which non-ambient sound (e.g., streaming audio corresponding to a phone conversation, media playback, video game, etc.) is played back through the speaker 1130, and an audio zoom mode or beamforming mode in which one or more ambient sounds are emphasized and/or other ambient sounds are suppressed for playback at the speaker 1130. In other embodiments, the earbuds 1102, 1104 may support fewer modes or may support one or more other modes in place of, or in addition to, the described modes. In a particular aspect, the speaker 1130 corresponds to the speaker 188 of FIG. 1.

In an illustrative example, the earbuds 1102, 1104 can automatically transition from the playback mode to the passthrough mode in response to detecting the wearer's voice while the speech 182 is captured by the microphone 186, and may automatically transition back to the playback mode after the wearer has ceased speaking to playback the output audio 116 via the speaker 188. In some examples, the earbuds 1102, 1104 can operate in two or more of the modes concurrently, such as by performing audio zoom on a particular ambient sound (e.g., a dog barking) and playing out the audio zoomed sound superimposed on the sound being played out while the wearer is listening to music (which can be reduced in volume while the audio zoomed sound is being played). In this example, the wearer can be alerted to the ambient sound associated with an audio event without halting playback of the music.

FIG. 12 is an embodiment 1200 in which the device 102 includes a wireless speaker and voice activated device 1202. The wireless speaker and voice activated device 1202 can have wireless network connectivity and is configured to execute an assistant operation. The one or more processors 190 including the microphone 186, the speaker 188, one or more of the speech analyzer 140, or a combination thereof, are included in the wireless speaker and voice activated device 1202. The wireless speaker and voice activated device 1202 also includes the speaker 188.

During operation, in response to receiving a verbal command identified as user speech, the wireless speaker and voice activated device 1202 can execute assistant operations, such as via execution of a voice activation system (e.g., an integrated assistant application). The assistant operations can include adjusting a temperature, playing music, turning on lights, etc. For example, the assistant operations are performed responsive to receiving a command after a keyword or key phrase (e.g., “hello assistant”). In some examples, the speech analyzer 140 processes the input audio 114 received via the microphone 186 to generate the output 130. In a particular aspect, the speech analyzer 140 outputs the output audio 116 via the speaker 188, outputs the GUI 118 to a display device, or both.

FIG. 13 depicts an embodiment 1300 in which the device 102 includes a portable electronic device that corresponds to a virtual reality, mixed reality, or augmented reality headset 1302. The microphone 186, the speaker 188, one or more components of the speech analyzer 140, or a combination thereof, are integrated into the headset 1302. In a particular aspect, the headset 1302 includes a first microphone 186 positioned to primarily capture speech of a user and a second microphone 186 positioned to primarily capture environmental sounds. Pronunciation feedback generation can be performed based on audio signals received from the microphone(s) 186 of the headset 1302. A visual interface device is positioned in front of the user's eyes to enable display of augmented reality, mixed reality, or virtual reality images or scenes to the user while the headset 1302 is worn. In a particular example, the visual interface device is configured to display a notification indicating pronunciation feedback, such as the GUI 118, the prosody score 426, the phonetic score 436, or a combination thereof.

FIG. 14 depicts an embodiment 1400 in which the device 102 corresponds to, or is integrated within, a vehicle 1402, illustrated as a manned or unmanned aerial device (e.g., a package delivery drone). The microphone 186, the speaker 188, one or more components of the speech analyzer 140, or a combination thereof, are integrated into the vehicle 1402. Pronunciation feedback generation can be performed based on audio signals received from the microphone 186 of the vehicle 1402, and the output audio 116 can be played back via the speaker 188.

FIG. 15 depicts another embodiment 1500 in which the device 102 corresponds to, or is integrated within, a vehicle 1502, illustrated as a car. The vehicle 1502 includes the one or more processors 190 including one or more components of the speech analyzer 140. The vehicle 1502 also includes the microphone 186 and the speaker 188. The microphone 186 is positioned to capture utterances of an operator of the vehicle 1502. Pronunciation feedback generation can be performed based on audio signals received from the microphone 186 of the vehicle 1502.

In a particular embodiment, in response to receiving a verbal command identified as user speech, the voice activation system 162 initiates one or more operations of the vehicle 1502 based on one or more keywords (e.g., “unlock,” “start engine,” “play music,” “display weather forecast,” or another voice command) detected in the input audio 114, such as by providing the GUI 118 via a display 1520 or the output audio 116 via one or more speakers (e.g., the speaker 188).

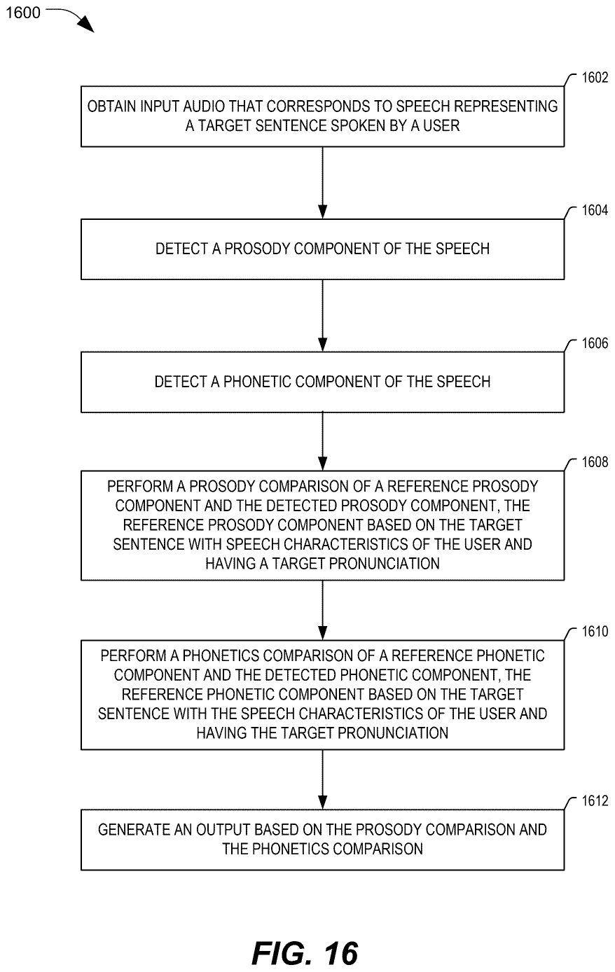

Referring to FIG. 16, a particular embodiment of a method 1600 of generating pronunciation feedback is shown. In a particular aspect, one or more operations of the method 1600 are performed by at least one of the FSEnc 150B, the pronunciation analyzer 152, the speech analyzer 140, the one or more processors 190, the device 102, the system 100 of FIG. 1, the FSEnc 250 of FIG. 2, the prosody encoder 370, the phonetic encoder 372 of FIG. 3, the prosody analyzer 442, the phonetics analyzer 444, the output generator 446 of FIG. 4A, or a combination thereof.

The method 1600 includes, at 1602, obtaining input audio that corresponds to speech representing a target sentence spoken by a user. For example, the pronunciation analyzer 152 of FIG. 1 obtains the input audio 114 that corresponds to the speech 182 representing a target sentence (e.g., corresponding to the target speech text 122) spoken by the user 180, as described with reference to FIG. 1.

The method 1600 also includes, at 1604, detecting a prosody component of the speech. For example, the FSEnc 150B of FIG. 1 detects the detected prosody component 156 of the speech 182, as described with reference to FIG. 1.

The method 1600 further includes, at 1606, detecting a phonetic component of the speech. For example, the FSEnc 150B of FIG. 1 detects the detected phonetic component 154 of the speech 182, as described with reference to FIG. 1.

The method 1600 also includes, at 1608, performing a prosody comparison of a reference prosody component and the detected prosody component, the reference prosody component based on the target sentence with speech characteristics of the user and having a target pronunciation. For example, the prosody analyzer 442 of FIG. 4A performs a prosody comparison of the reference prosody component 166 and the detected prosody component 156. The reference prosody component 166 based on the target sentence (e.g., corresponding to the target speech text 122) with speech characteristics (e.g., represented by the user speech embedding 120) of the user 180 and having a target pronunciation (e.g., represented by the target pronunciation parameter 124), as described with reference to FIG. 4A.

The method 1600 further includes, at 1610, performing a phonetics comparison of a reference phonetic component and the detected phonetic component, the reference phonetic component based on the target sentence with the speech characteristics of the user and having the target pronunciation. For example, the phonetics analyzer 444 of FIG. 4A performs a phonetics comparison of the reference phonetic component 164 and the detected phonetic component 154. The reference phonetic component 164 based on the target sentence (e.g., corresponding to the target speech text 122) with speech characteristics (e.g., represented by the user speech embedding 120) of the user 180 and having a target pronunciation (e.g., represented by the target pronunciation parameter 124), as described with reference to FIG. 4A.

The method 1600 also includes, at 1612, generating an output based on the prosody comparison and the phonetics comparison. For example, the output generator 446 of FIG. 4A generates the output 130 based on the prosody score 426 corresponding to the prosody comparison and the phonetic score 436 corresponding to the phonetics comparison, as described with reference to FIG. 4A.

A technical advantage of the method 1600 includes improving pronunciation feedback. For example, the output 130 is generated based on a comparison of audio data corresponding to detected speech of the user 180 and reference audio data that has speech characteristics of the user 180 (e.g., instead of reference audio data corresponding to speech of another person) so that any differences are more likely to correspond to pronunciation inaccuracies than individual speech differences of the user 180.

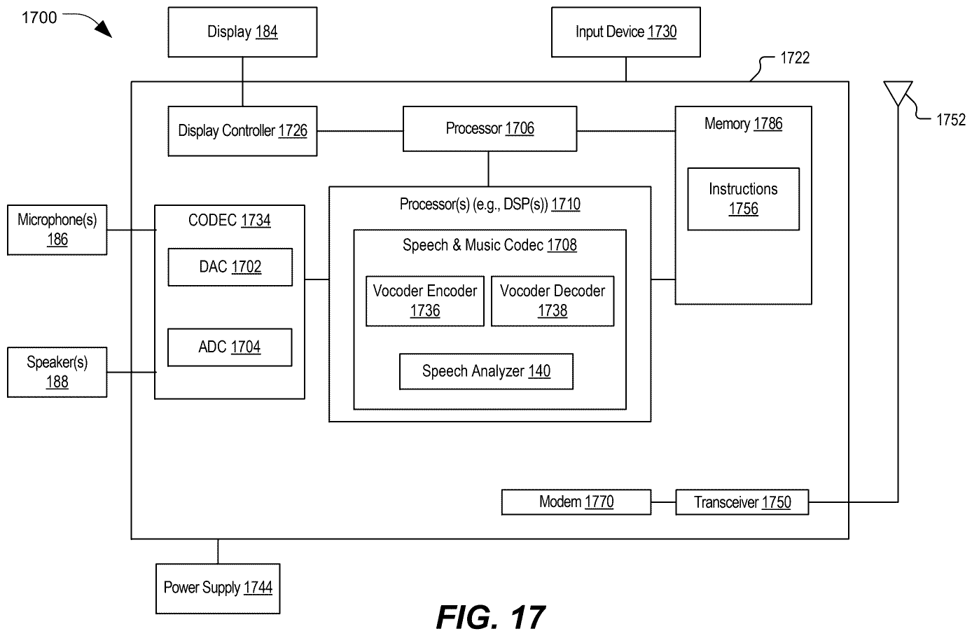

The method 1600 of FIG. 16 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 1600 of FIG. 16 may be performed by a processor that executes instructions, such as described with reference to FIG. 17.

Referring to FIG. 17, a block diagram of a particular illustrative embodiment of a device is depicted and generally designated 1700. In various embodiments, the device 1700 may have more or fewer components than illustrated in FIG. 17. In an illustrative embodiment, the device 1700 may correspond to the device 102. In an illustrative embodiment, the device 1700 may perform one or more operations described with reference to FIGS. 1-16.

In a particular embodiment, the device 1700 includes a processor 1706 (e.g., a CPU). The device 1700 may include one or more additional processors 1710 (e.g., one or more DSPs). In a particular aspect, the one or more processors 190 of FIG. 1 correspond to the processor 1706, the processors 1710, or a combination thereof. The processors 1710 may include a speech and music coder-decoder (CODEC) 1708 that includes a voice coder (“vocoder”) encoder 1736, a vocoder decoder 1738, the speech analyzer 140, or a combination thereof.

The device 1700 may include a memory 1786 and a CODEC 1734. The memory 1786 may include instructions 1756, that are executable by the one or more additional processors 1710 (or the processor 1706) to implement the functionality described with reference to the speech analyzer 140. The device 1700 may include a modem 1770 coupled, via a transceiver 1750, to an antenna 1752.

The device 1700 may include the display device 184 coupled to a display controller 1726. One or more speakers 188 and one or more microphones 186 may be coupled to the CODEC 1734. The CODEC 1734 may include a digital-to-analog converter (DAC) 1702, an analog-to-digital converter (ADC) 1704, or both. In a particular embodiment, the CODEC 1734 may receive analog signals from the microphone 186, convert the analog signals to digital signals using the analog-to-digital converter 1704, and provide the digital signals to the speech and music codec 1708. The speech and music codec 1708 may process the digital signals, and the digital signals may further be processed by the speech analyzer 140. In a particular embodiment, the speech and music codec 1708 may provide digital signals to the CODEC 1734. The CODEC 1734 may convert the digital signals to analog signals using the digital-to-analog converter 1702 and may provide the analog signals to the one or more speakers 188.

In a particular embodiment, the device 1700 may be included in a system-in-package or system-on-chip device 1722. In a particular embodiment, the memory 1786, the processor 1706, the processors 1710, the display controller 1726, the CODEC 1734, and the modem 1770 are included in the system-in-package or system-on-chip device 1722. In a particular embodiment, an input device 1730 and a power supply 1744 are coupled to the system-in-package or the system-on-chip device 1722. Moreover, in a particular embodiment, as illustrated in FIG. 17, the display device 184, the input device 1730, the one or more speakers 188, the one or more microphones 186, the antenna 1752, and the power supply 1744 are external to the system-in-package or the system-on-chip device 1722. In a particular embodiment, each of the display device 184, the input device 1730, the one or more speakers 188, the one or more microphones 186, the antenna 1752, and the power supply 1744 may be coupled to a component of the system-in-package or the system-on-chip device 1722, such as an interface or a controller.

The device 1700 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for obtaining input audio that corresponds to speech representing a target sentence spoken by a user. For example, the means for obtaining input audio can correspond to the microphone 186, the FSEnc 150B, the speech analyzer 140, the one or more processors 190, the device 102, the system 100 of FIG. 1, the FSEnc 250 of FIG. 2, the prosody encoder 370, the phonetic encoder 372, the speaker encoder 374 of FIG. 3, the processor 1706, the additional processor(s) 1710, the antenna 1752, the transceiver 1750, the modem 1770, the device 1700, one or more other circuits or components configured to obtain the input audio, or any combination thereof.

The apparatus also includes means for detecting a prosody component of the speech. For example, the means for detecting a prosody component can correspond to the FSEnc 150B, the speech analyzer 140, the one or more processors 190, the device 102, the system 100 of FIG. 1, the FSEnc 250 of FIG. 2, the prosody encoder 370 of FIG. 3, the processor 1706, the additional processor(s) 1710, the device 1700, one or more other circuits or components configured to detect the prosody component, or any combination thereof.

The apparatus further includes means for detecting a phonetic component of the speech. For example, the means for detecting a phonetic component can correspond to the FSEnc 150B, the speech analyzer 140, the one or more processors 190, the device 102, the system 100 of FIG. 1, the FSEnc 250 of FIG. 2, the phonetic encoder 372 of FIG. 3, the processor 1706, the additional processor(s) 1710, the device 1700, one or more other circuits or components configured to detect the phonetic component, or any combination thereof.

The apparatus also includes means for performing a prosody comparison of a reference prosody component and the detected prosody component. The reference prosody component is based on the target sentence with speech characteristics of the user and having a target pronunciation. For example, the means for performing a prosody comparison can correspond to the pronunciation analyzer 152, the speech analyzer 140, the one or more processors 190, the device 102, the system 100 of FIG. 1, the prosody analyzer 442 of FIG. 4A, the processor 1706, the additional processor(s) 1710, the device 1700, one or more other circuits or components configured to perform the prosody comparison, or any combination thereof.

The apparatus also includes means for performing a phonetics comparison of a reference phonetic component and the detected phonetic component. The reference phonetic component is based on the target sentence with the speech characteristics of the user and having the target pronunciation. For example, the means for performing a phonetics comparison can correspond to the pronunciation analyzer 152, the speech analyzer 140, the one or more processors 190, the device 102, the system 100 of FIG. 1, the phonetics analyzer 444 of FIG. 4A, the processor 1706, the additional processor(s) 1710, the device 1700, one or more other circuits or components configured to perform the phonetics comparison, or any combination thereof.

The apparatus further includes means for generating an output based on the prosody comparison and the phonetics comparison. For example, the means for generating an output can correspond to the pronunciation analyzer 152, the speech analyzer 140, the one or more processors 190, the device 102, the system 100 of FIG. 1, the output generator 446 of FIG. 4A, the processor 1706, the additional processor(s) 1710, the device 1700, one or more other circuits or components configured to generate the output, or any combination thereof.

In some implementations, a non-transitory computer-readable medium (e.g., a computer-readable storage device, such as the memory 1786) includes instructions (e.g., the instructions 1756) that, when executed by one or more processors (e.g., the one or more processors 1710 or the processor 1706), cause the one or more processors to obtain input audio (e.g., the input audio 114) that corresponds to speech (e.g., the speech 182) representing a target sentence (e.g., corresponding to the target speech text 122) spoken by a user (e.g., the user 180). The instructions further cause the one or more processors to detect a prosody component (e.g., the detected prosody component 156) of the speech. The instructions further cause the one or more processors to detect a phonetic component (e.g., the detected phonetic component 154) of the speech. The instructions further cause the one or more processors to perform a prosody comparison of a reference prosody component (e.g., the reference prosody component 166) and the detected prosody component. The reference prosody component is based on the target sentence with speech characteristics (e.g., represented by the user speech embedding 120) of the user and having a target pronunciation (e.g., represented by the target pronunciation parameter 124). The instructions further cause the one or more processors to perform a phonetics comparison of a reference phonetic component (e.g., the reference phonetic component 164) and the detected phonetic component. The reference phonetic component is based on the target sentence with the speech characteristics of the user and having the target pronunciation. The instructions further cause the one or more processors to generate an output (e.g., the output 130) based on the prosody comparison and the phonetics comparison.

Particular aspects of the disclosure are described below in sets of interrelated Examples:

According to Example 1, a device includes a memory configured to store input audio that corresponds to speech representing a target sentence spoken by a user. The device also includes one or more processors coupled to the memory and configured to detect a prosody component of the speech; detect a phonetic component of the speech; perform a prosody comparison of a reference prosody component and the detected prosody component, the reference prosody component based on the target sentence with speech characteristics of the user and having a target pronunciation; perform a phonetics comparison of a reference phonetic component and the detected phonetic component, the reference phonetic component based on the target sentence with the speech characteristics of the user and having the target pronunciation; and generate an output based on the prosody comparison and the phonetics comparison.

Example 2 includes the device of Example 1, wherein the reference prosody component includes multiple reference sample prosody components, each of the multiple reference sample prosody components based on the target sentence with the speech characteristics of the user, a respective distinct speech manner, and having the target pronunciation.

Example 3 includes the device of Example 2, wherein the prosody comparison is based on a comparison of the detected prosody component and each of the multiple reference sample prosody components.

Example 4 includes the device of any of Examples 1 to 3, wherein the reference phonetic component includes multiple reference sample phonetic components, each of the multiple reference sample phonetic components based on the target sentence with the speech characteristics of the user, a respective distinct speech manner, and having the target pronunciation.

Example 5 includes the device of Example 4, wherein the phonetics comparison is based on a comparison of the detected phonetic component and each of the multiple reference sample phonetic components.

Example 6 includes the device of any of Examples 1 to 5, wherein the one or more processors are configured to generate reference audio that corresponds to synthesized speech that represents the target sentence having the speech characteristics of the user and having the target pronunciation, wherein the reference prosody component and the reference phonetic component are based on the reference audio.

Example 7 includes the device of Example 6, wherein the one or more processors are configured to generate, at a personalized text-to-speech engine, the reference audio based on the target sentence and a user speech embedding corresponding to the user.

Example 8 includes the device of Example 7, wherein the personalized text-to-speech engine includes an end-to-end speech synthesis model that is based on variational interference with adversarial learning for end-to-end speech synthesis (VITS).

Example 9 includes the device of any of Examples 6 to 8, wherein the reference audio includes multiple reference audio samples, each of the multiple reference audio samples corresponds to synthesized speech that represents the target sentence having the speech characteristics of the user, a respective distinct speech manner, and having the target pronunciation.

Example 10 includes the device of Example 9, wherein the reference prosody component includes multiple reference sample prosody components, wherein each of the multiple reference sample prosody components is based on a respective one of the multiple reference audio samples, and wherein the prosody comparison is based on a comparison of the detected prosody component and each of the multiple reference sample prosody components.

Example 11 includes the device of Example 9 or Example 10, wherein the reference phonetic component includes multiple reference sample phonetic components, wherein each of the multiple reference sample phonetic components based on a respective one of the multiple reference audio samples, and wherein the phonetics comparison is based on a comparison of the detected phonetic component and each of the multiple reference sample phonetic components.

Example 12 includes the device of any of Examples 1 to 11, wherein the one or more processors are configured to process, at a factorized speech encoder, the input audio to generate an encoder output that includes at least the detected prosody component and the detected phonetic component.

Example 13 includes the device of Example 12, wherein the one or more processors are configured to process, at the factorized speech encoder, reference audio to generate a reference encoder output that includes at least the reference prosody component and the reference phonetic component, wherein the reference audio corresponds to synthesized speech that represents the target sentence having the speech characteristics of the user and having the target pronunciation, wherein the encoder output includes a detected speaker vocal characteristics component, and wherein the reference encoder output includes a reference speaker vocal characteristics component.

Example 14 includes the device of any of Examples 1 to 13, wherein the one or more processors are configured to generate a prosody score based on the prosody comparison; and generate a phonetic score based on the phonetics comparison, wherein the output is based on the prosody score and the phonetic score.

Example 15 includes the device of any of Examples 1 to 14, wherein the one or more processors are configured to generate the output including a graphical user interface (GUI) that indicates results of at least the prosody comparison or the phonetics comparison aligned with respective phonemes of the target sentence.

Example 16 includes the device of any of Examples 1 to 15, wherein the one or more processors are configured to provide the output to a large language model (LLM) to generate feedback on a presentation that includes at least the target sentence, wherein the feedback includes at least one of speech speed feedback, pronunciation suggestion, or speech duration feedback.

Example 17 includes the device of Example 16, wherein the one or more processors are configured to provide the input audio and reference audio to the LLM to generate the feedback, wherein the reference audio corresponds to synthesized speech that represents the target sentence having the speech characteristics of the user and having the target pronunciation.

Example 18 includes the device of any of Examples 1 to 17 and further includes a microphone configured to receive the input audio.

According to Example 19, a method includes obtaining, at a device, input audio that corresponds to speech representing a target sentence spoken by a user; detecting, at the device, a prosody component of the speech; detecting, at the device, a phonetic component of the speech; performing, at the device, a prosody comparison of a reference prosody component and the detected prosody component, the reference prosody component based on the target sentence with speech characteristics of the user and having a target pronunciation; performing, at the device, a phonetics comparison of a reference phonetic component and the detected phonetic component, the reference phonetic component based on the target sentence with the speech characteristics of the user and having the target pronunciation; and generating, at the device, an output based on the prosody comparison and the phonetics comparison.

Example 20 includes the method of Example 19, wherein the reference prosody component includes multiple reference sample prosody components, each of the multiple reference sample prosody components based on the target sentence with the speech characteristics of the user, a respective distinct speech manner, and having the target pronunciation.

Example 21 includes the method of Example 20, wherein the prosody comparison is based on a comparison of the detected prosody component and each of the multiple reference sample prosody components.

Example 22 includes the method of any of Examples 19 to 21, wherein the reference phonetic component includes multiple reference sample phonetic components, each of the multiple reference sample phonetic components based on the target sentence with the speech characteristics of the user, a respective distinct speech manner, and having the target pronunciation.

Example 23 includes the method of Example 22, wherein the phonetics comparison is based on a comparison of the detected phonetic component and each of the multiple reference sample phonetic components.

Example 24 includes the method of any of Examples 19 to 23 and further includes generating reference audio that corresponds to synthesized speech that represents the target sentence having the speech characteristics of the user and having the target pronunciation, wherein the reference prosody component and the reference phonetic component are based on the reference audio.

Example 25 includes the method of Example 24 and further includes generating, at a personalized text-to-speech engine, the reference audio based on the target sentence and a user speech embedding corresponding to the user.

Example 26 includes the method of Example 25, wherein the personalized text-to-speech engine includes an end-to-end speech synthesis model that is based on variational interference with adversarial learning for end-to-end speech synthesis (VITS).

Example 27 includes the method of any of Examples 24 to 26, wherein the reference audio includes multiple reference audio samples, each of the multiple reference audio samples corresponds to synthesized speech that represents the target sentence having the speech characteristics of the user, a respective distinct speech manner, and having the target pronunciation.

Example 28 includes the method of Example 27, wherein the reference prosody component includes multiple reference sample prosody components, wherein each of the multiple reference sample prosody components is based on a respective one of the multiple reference audio samples, and wherein the prosody comparison is based on a comparison of the detected prosody component and each of the multiple reference sample prosody components.

Example 29 includes the method of Example 27 or Example 28, wherein the reference phonetic component includes multiple reference sample phonetic components, wherein each of the multiple reference sample phonetic components based on a respective one of the multiple reference audio samples, and wherein the phonetics comparison is based on a comparison of the detected phonetic component and each of the multiple reference sample phonetic components.

Example 30 includes the method of any of Examples 19 to 29 and further includes processing, at a factorized speech encoder, the input audio to generate an encoder output that includes at least the detected prosody component and the detected phonetic component.

Example 31 includes the method of Example 30 and further includes processing, at the factorized speech encoder, reference audio to generate a reference encoder output that includes at least the reference prosody component and the reference phonetic component, wherein the reference audio corresponds to synthesized speech that represents the target sentence having the speech characteristics of the user and having the target pronunciation, wherein the encoder output includes a detected speaker vocal characteristics component, and wherein the reference encoder output includes a reference speaker vocal characteristics component.

Example 32 includes the method of any of Examples 19 to 31 and further includes generating a prosody score based on the prosody comparison; and generating a phonetic score based on the phonetics comparison, wherein the output is based on the prosody score and the phonetic score.

Example 33 includes the method of any of Examples 19 to 32 and further includes generating the output including a graphical user interface (GUI) that indicates results of at least the prosody comparison or the phonetics comparison aligned with respective phonemes of the target sentence.

Example 34 includes the method of any of Examples 19 to 33 and further includes providing the output to a large language model (LLM) to generate feedback on a presentation that includes at least the target sentence, wherein the feedback includes at least one of speech speed feedback, pronunciation suggestion, or speech duration feedback.

Example 35 includes the method of Example 34 and further includes providing the input audio and reference audio to the LLM to generate the feedback, wherein the reference audio corresponds to synthesized speech that represents the target sentence having the speech characteristics of the user and having the target pronunciation.

Example 36 includes the method of any of Examples 19 to 35 and further includes receiving the input audio from a microphone.

According to Example 37, a non-transitory computer-readable medium storing instructions that, when executed by one or more processors, cause the one or more processors to obtain input audio that corresponds to speech representing a target sentence spoken by a user; detect prosody component of the speech; detect a phonetic component of the speech; perform a prosody comparison of a reference prosody component and the detected prosody component, the reference prosody component based on the target sentence with speech characteristics of the user and having a target pronunciation; perform a phonetics comparison of a reference phonetic component and the detected phonetic component, the reference phonetic component based on the target sentence with the speech characteristics of the user and having the target pronunciation; and generate an output based on the prosody comparison and the phonetics comparison.

According to Example 38, an apparatus includes means for obtaining input audio that corresponds to speech representing a target sentence spoken by a user; means for detecting a prosody component of the speech; means for detecting a phonetic component of the speech; means for performing a prosody comparison of a reference prosody component and the detected prosody component, the reference prosody component based on the target sentence with speech characteristics of the user and having a target pronunciation; means for performing a phonetics comparison of a reference phonetic component and the detected phonetic component, the reference phonetic component based on the target sentence with the speech characteristics of the user and having the target pronunciation; and means for generating an output based on the prosody comparison and the phonetics comparison.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store input audio that corresponds to speech representing a target sentence spoken by a user; and
one or more processors coupled to the memory and configured to:
detect a prosody component of the speech;
detect a phonetic component of the speech;
perform a prosody comparison of a reference prosody component and the detected prosody component, the reference prosody component based on the target sentence with speech characteristics of the user and having a target pronunciation;
perform a phonetics comparison of a reference phonetic component and the detected phonetic component, the reference phonetic component based on the target sentence with the speech characteristics of the user and having the target pronunciation; and
generate an output based on the prosody comparison and the phonetics comparison.

2. The device of claim 1, wherein the reference prosody component includes multiple reference sample prosody components, each of the multiple reference sample prosody components based on the target sentence with the speech characteristics of the user, a respective distinct speech manner, and having the target pronunciation.

3. The device of claim 2, wherein the prosody comparison is based on a comparison of the detected prosody component and each of the multiple reference sample prosody components.

4. The device of claim 1, wherein the reference phonetic component includes multiple reference sample phonetic components, each of the multiple reference sample phonetic components based on the target sentence with the speech characteristics of the user, a respective distinct speech manner, and having the target pronunciation.

5. The device of claim 4, wherein the phonetics comparison is based on a comparison of the detected phonetic component and each of the multiple reference sample phonetic components.

6. The device of claim 1, wherein the one or more processors are configured to generate reference audio that corresponds to synthesized speech that represents the target sentence having the speech characteristics of the user and having the target pronunciation, wherein the reference prosody component and the reference phonetic component are based on the reference audio.

7. The device of claim 6, wherein the one or more processors are configured to generate, at a personalized text-to-speech engine, the reference audio based on the target sentence and a user speech embedding corresponding to the user.

8. The device of claim 7, wherein the personalized text-to-speech engine includes an end-to-end speech synthesis model that is based on variational interference with adversarial learning for end-to-end speech synthesis (VITS).

9. The device of claim 6, wherein the reference audio includes multiple reference audio samples, each of the multiple reference audio samples corresponds to synthesized speech that represents the target sentence having the speech characteristics of the user, a respective distinct speech manner, and having the target pronunciation.

10. The device of claim 9, wherein the reference prosody component includes multiple reference sample prosody components, wherein each of the multiple reference sample prosody components is based on a respective one of the multiple reference audio samples, and wherein the prosody comparison is based on a comparison of the detected prosody component and each of the multiple reference sample prosody components.

11. The device of claim 9, wherein the reference phonetic component includes multiple reference sample phonetic components, wherein each of the multiple reference sample phonetic components based on a respective one of the multiple reference audio samples, and wherein the phonetics comparison is based on a comparison of the detected phonetic component and each of the multiple reference sample phonetic components.

12. The device of claim 1, wherein the one or more processors are configured to process, at a factorized speech encoder, the input audio to generate an encoder output that includes at least the detected prosody component and the detected phonetic component.

13. The device of claim 12, wherein the one or more processors are configured to process, at the factorized speech encoder, reference audio to generate a reference encoder output that includes at least the reference prosody component and the reference phonetic component, wherein the reference audio corresponds to synthesized speech that represents the target sentence having the speech characteristics of the user and having the target pronunciation, wherein the encoder output includes a detected speaker vocal characteristics component, and wherein the reference encoder output includes a reference speaker vocal characteristics component.

14. The device of claim 1, wherein the one or more processors are configured to:
generate a prosody score based on the prosody comparison; and
generate a phonetic score based on the phonetics comparison, wherein the output is based on the prosody score and the phonetic score.

15. The device of claim 1, wherein the one or more processors are configured to generate the output including a graphical user interface (GUI) that indicates results of at least the prosody comparison or the phonetics comparison aligned with respective phonemes of the target sentence.

16. The device of claim 1, wherein the one or more processors are configured to provide the output to a large language model (LLM) to generate feedback on a presentation that includes at least the target sentence, wherein the feedback includes at least one of speech speed feedback, pronunciation suggestion, or speech duration feedback.

17. The device of claim 16, wherein the one or more processors are configured to provide the input audio and reference audio to the LLM to generate the feedback, wherein the reference audio corresponds to synthesized speech that represents the target sentence having the speech characteristics of the user and having the target pronunciation.

18. The device of claim 1, further comprising a microphone configured to receive the input audio.

19. A method comprising:
obtaining, at a device, input audio that corresponds to speech representing a target sentence spoken by a user;
detecting, at the device, a prosody component of the speech;
detecting, at the device, a phonetic component of the speech;
performing, at the device, a prosody comparison of a reference prosody component and the detected prosody component, the reference prosody component based on the target sentence with speech characteristics of the user and having a target pronunciation;
performing, at the device, a phonetics comparison of a reference phonetic component and the detected phonetic component, the reference phonetic component based on the target sentence with the speech characteristics of the user and having the target pronunciation; and
generating, at the device, an output based on the prosody comparison and the phonetics comparison.

20. A non-transitory computer-readable medium storing instructions that, when executed by one or more processors, cause the one or more processors to:
obtain input audio that corresponds to speech representing a target sentence spoken by a user;
detect prosody component of the speech;
detect a phonetic component of the speech;
perform a prosody comparison of a reference prosody component and the detected prosody component, the reference prosody component based on the target sentence with speech characteristics of the user and having a target pronunciation;
perform a phonetics comparison of a reference phonetic component and the detected phonetic component, the reference phonetic component based on the target sentence with the speech characteristics of the user and having the target pronunciation; and
generate an output based on the prosody comparison and the phonetics comparison.
